(19) United States
(12) Patent Application Publication
(10) Pub. No.: US 2004/0186912 A1
(43) Pub. Date: Sep. 23, 2004

(54) Method and system for transparently supporting digital signatures associated with web transactions

(75) Inventors: Nicholas George Harlow, Deerfield, MA (US); Lawrence Wai Leung, Azusa, CA (US); Amy Lien McIntyre, Richmond, CA (US); Ivan Matthew Milman, Austin, TX (US); Sridhar R. Muppidi, Austin, TX (US); Bryan Thomas, Chapel Hill, NC (US); Mark Vandenwauver, Round Rock, TX (US)

Correspondence Address: Joseph R. Burwell, Law Office of Joseph R. Burwell, P. O. Box 28022, Austin, TX, 78755-8022, US

(73) Assignee: INTERNATIONAL BUSINESS MACHINES CORPORATION, Armonk, NY

(21) Appl. No.: 10/394,302

(22) Filed: Mar. 20, 2003

(51) Int. Cl. G06F 15/16; G06F 12/14; G06F 11/30; H04L 9/32

(52) U.S. Cl. 709/237; 713/200; 709/229

(57) ABSTRACT

A method, system, apparatus, and computer program product are presented for transparently adding digital signature functionality to web servers in order to extend the web servers to generate and enforce signatures on transaction data on behalf of web applications that are processing transactions. A server plug-in intercepts transaction data that is submitted by a client to a web application. The plug-in returns a document containing the intercepted transaction data along with an applet that is executable at the client. When the applet is executed at the client, it generates a digital signature on the transaction data using a key that is stored at the client and returns a different document with the intercepted transaction data and with the newly generated signature. The plug-in validates the signature, records the signature in server-side log file, returns a signature receipt to the client, and forwards the transaction data to the destination web application.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for multicomputer communication using cryptography.

2. Description of Related Art

E-commerce web sites and web applications perform transactions over computer networks using form input such as HTML (HyperText Markup Language) forms. These online transactions can involve the transfer of high value data that is crucial to the operation of businesses, including financial decisions and purchase orders.

The ability to digitally sign these transactions using public key technology decreases the risk to both parties to a transaction, e.g., a customer and a merchant. A digital signature provides the merchant with a means to verify the identity of the customer and to determine that the customer is authorized to perform the transaction. In addition, the digital signature supports non-repudiation of a transaction because the digital signature can be incorporated into transaction histories by both parties. The merchant can store the digital signature in a transaction log as proof of receiving the transaction from the customer, and the customer can receive a digital equivalent of a paper receipt from the merchant that incorporates the customer's signature, after which the customer can store the receipt in the customer's transaction log.

Unfortunately, the incorporation of digital signature functionality into legacy systems usually requires extensive modification to web applications and/or client applications. Such modifications are costly because they require extra development effort to add digital signature generation and verification functionality to existing applications. If the source code of a web application is not available, as is often the case, it may not be possible to add digital signature functionality without assistance from the vendor of a software application.

Therefore, it would be advantageous to have a method and system to transparently add digital signature functionality to web applications in order to extend the web applications to generate and enforce signatures.

### SUMMARY OF THE INVENTION

A method, system, apparatus, and computer program product are presented for transparently adding digital signature functionality to web servers in order to extend the web servers to generate and enforce signatures on transaction data on behalf of web applications that are processing transactions. A server plug-in intercepts transaction data that is submitted by a client to a web application for a pending transaction. The plug-in returns a document, e.g., an HTML document, containing the intercepted transaction data along with an applet that is executable at the client. When the applet is executed at the client, e.g., by a browser application, it generates a digital signature on the transaction data using a cryptographic key that is stored at the client. The applet then returns a document, e.g., an XML signature document, containing the newly generated signature along with the intercepted transaction data, i.e. the data that has been signed. The plug-in intercepts the incoming document, extracts the signature, validates the signature, records the signature in server-side log file, returns a signature receipt to the client, and forwards the transaction data to the web application that is processing the pending transaction. Given that a server-side plug-in and a client-side applet are employed, the operator of a domain obtains the advantages provided by digital signatures, such as verifiable identity and non-repudiation of transactions, with the avoidance of modifications to web applications and client applications.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a block diagram that shows some of the data flow between a client and a server in accordance with the present invention;

FIG. 3 depicts a block diagram that shows a web server whose functionality has been extended to support the addition of digital signature processing in conjunction with legacy transaction data processing;

FIG. 4 depicts a flowchart that shows a process for intercepting transaction data from a client at a web server and requesting a digital signature for the pending transaction from the client;

FIG. 5 depicts a flowchart that shows a process at a client for generating a digital signature for a transaction as required by a web server as part of the process for accepting the transaction data from the client; and

FIG. 6 depicts a flowchart that shows a process for intercepting transaction data at a web server and enforcing the capture of a digital signature for the pending transaction prior to forwarding the transaction data to a web application.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

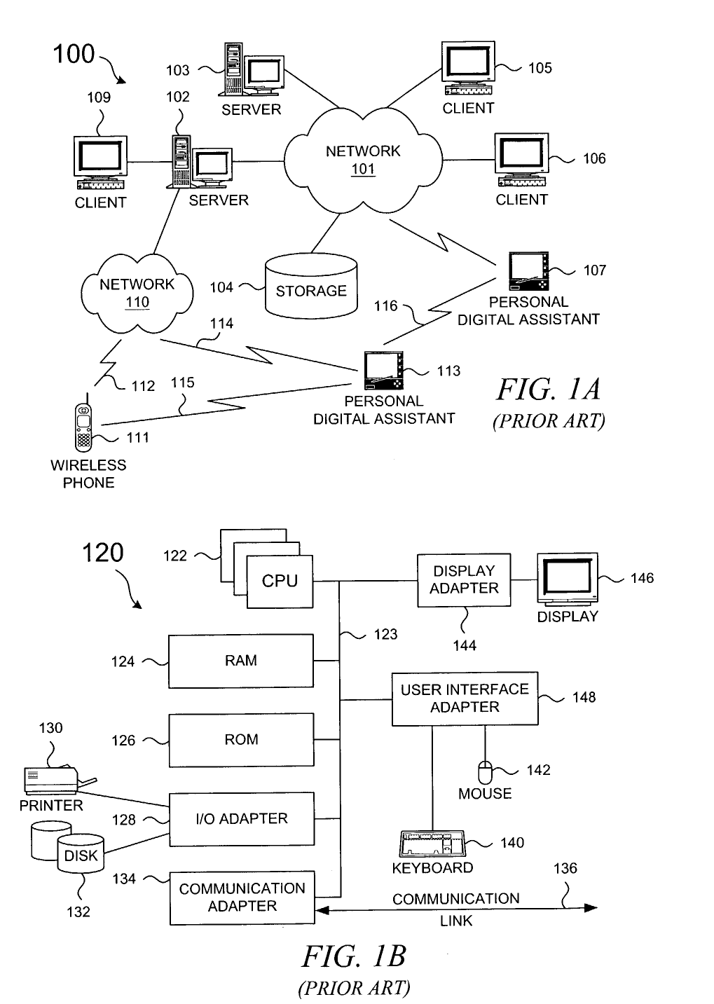

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to decreasing the risks and liabilities to parties that are participating in a transaction that is occurring within a distributed data processing system, as described in more detail below with respect to the remaining figures.

The descriptions of the figures herein involve certain actions by either a client device or a user of the client device. One of ordinary skill in the art would understand that responses and/or requests to/from the client are sometimes initiated by a user and at other times are initiated automatically by a client, often on behalf of a user of the client. Hence, when a client or a user of a client is mentioned in the description of the figures, it should be understood that the terms “client” and “user” can be used interchangeably without significantly affecting the meaning of the described processes.

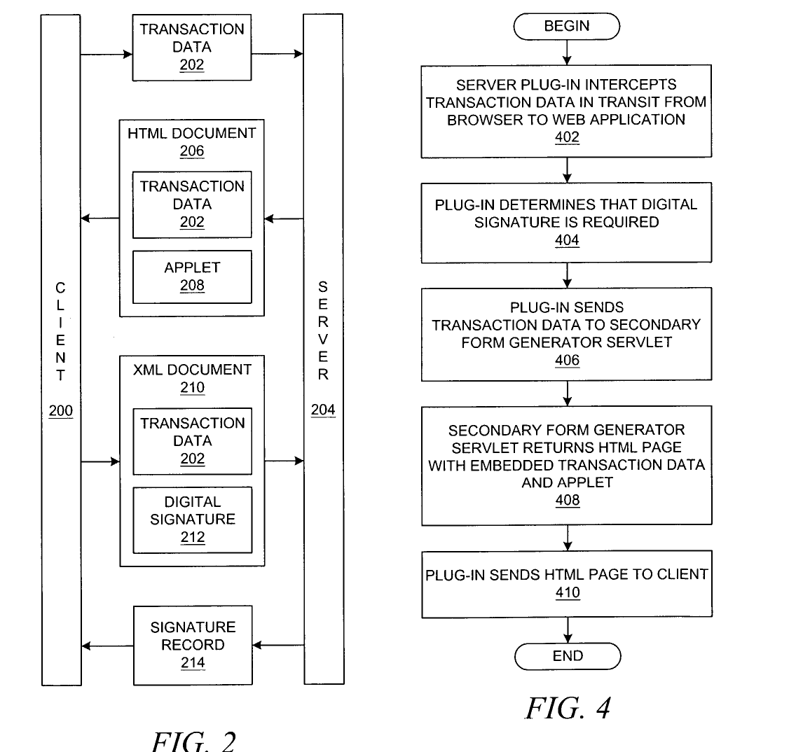

With reference now to FIG. 2, a block diagram depicts some of the data flow between a client and a server in accordance with the present invention. FIG. 2 provides a visual summary of a portion of the transaction data flow within the present invention. A user at client 200 performs an action that causes the client 200 to send transaction data 202 to server 204; client 200 and server 204 are operating within a distributed data processing system such as those described above with respect to FIG. 1A and FIG. 1B. In response, server 204 returns document 206 that contains transaction data 202 and applet 208; document 206 may be an HTML document that is interpretable by a browser application at client 200, and applet 208 may be a Java applet that is executable by the browser application at client 200.

Client 200 executes applet 208, which digitally signs transaction data 202 using a digital cryptographic key possessed by the user. Applet 208 returns XML document 210 that contains transaction data 202 and digital signature 212. In response to successful processing and acceptance of the digital signature, server 204 returns signature record 214, which may formatted as an XML document.

It should be noted that the client-side application is not required to be a browser and may be a different type of application that comprises the ability to generate transaction data, interpret documents, and execute applets. Moreover, the documents and/or messages that are transferred between the client and the server are not required to be formatted with markup language and may adhere to any format that is commonly interpretable by the client and the server.

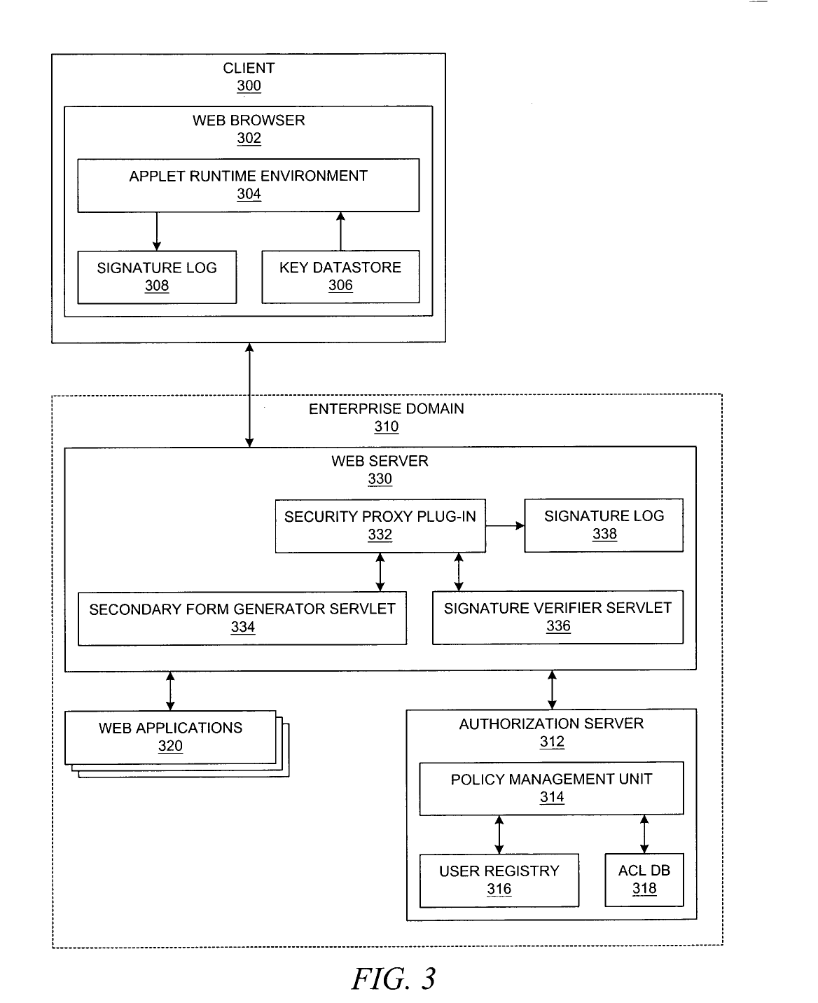

With reference now to FIG. 3, a block diagram depicts a web server whose functionality has been extended to support the addition of digital signature processing in conjunction with legacy transaction data processing in accordance with an embodiment of the present invention. Client 300 executes web browser application 302 or a similar client application for accessing resources and services from various web applications. Browser 302 supports applet runtime environment 304, which may comprise a virtual machine. Browser 302 and supported applets can access key datastore 306 in which the client maintains the user's cryptographic keys. In addition, browser 302 and supported applets can access signature log 308, which contains a log of the signatures that have been generated at client 300 along with signature records/receipts that have been returned from web servers in response to the submission of signatures from client 300.

Enterprise domain 310 comprises authorization server 312. Authorization policy management unit 314 at authorization server 312 manages information within user registry 316 and access control list (ACL) database 318. Policy management unit 314 determines whether users are authorized to access certain services that are provided by web applications 320 within domain 310 by checking policies against user requests for those services.

Domain 310 also comprises web server 330, which may perform many duties within domain 310, including acting as a reverse proxy and enforcing security requirements for the data systems within domain 310. Web server 330 supports security proxy plug-in 332, secondary form generator servlet 334, and signature verifier servlet 336, which are explained in more detail further below. Security proxy plug-in 332 maintains signature log 338 of received and/or verified client signatures that have been returned from clients in response to a requirement from web server 332, as explained further below.

With reference now to FIG. 4, a flowchart depicts a process for intercepting transaction data from a client at a web server and requesting a digital signature for the pending transaction from the client. In the following example, it may be assumed that a web application has sent a form document, such as an HTML form, to the user's browser in order to request information for an associated transaction. The user has subsequently entered transaction-related information into the form document, and upon a certain action by the user, such as selection of an OK button within the form document, the browser has submitted the form data to the web application, e.g., using an HTTP POST message.

The process begins with a web server plug-in, similar to security proxy plug-in 332 in FIG. 3, intercepting transaction data (step 402) that is being submitted by a client to a web application. A server plug-in is a shared object, shared library, or a small application that extends the functionality of a server. Plug-ins are typically registered within a configuration file for the server, and the server calls the plug-in for certain events, such as the receipt of incoming messages. In this example, the plug-in has been invoked by the server to examine the incoming transaction data, and the plug-in intercepts the transaction data, possibly based on certain criteria, such as the type of transaction data or the destination web application.

Rather than forwarding the transaction data to the destination web application, the plug-in determines whether the transaction requires a digital signature by checking with a policy manager or authorization server (step 404). In order to provide the authorizing component with the appropriate information, the plug-in may send a query to the authorization server in which the query identifies the requested action along with user identity information from a previously completed authentication operation.

Assuming that a digital signature is required as indicated in a response from the authorization server, the plug-in forwards the transaction data to a secondary form generator servlet (step 406), which generates and returns an HTML page containing the transaction data embedded within the page along with some script statements and an applet, e.g., JavaScript statements and a Java applet (step 408). The plug-in forwards the newly generated HTML page to the client (step 410), and the process is complete.

FIG. 4 depicts an initial phase of collecting a digital signature in which a web server determines that a digital signature is required and sends a request to the client to generate a digital signature. FIG. 5 shows some of the processing that occurs at the client to obtain the digital signature that is requested by the web server, and FIG. 6 shows some of the processing that occurs at the web server when the client returns the requested digital signature.

With reference now to FIG. 5, a flowchart depicts a process at a client for generating a digital signature for a transaction as required by a web server as part of the process for accepting the transaction data from the client. The process begins with a browser at a client receiving the HTML page with the embedded transaction data and applet (step 502). The browser processes the web page and executes the applet (step 504), which prompts the user to input the identifier of a key datastore, such as a file on the client, along with a password to unlock the key datastore (step 506).

The mechanism by which the applet prompts the user or otherwise operates may vary depending upon the implementation of the invention. The applet may prompt the user by presenting a web page within the browser window that explains the need to produce a digital signature for the pending transaction, and the presented web page may have an OK button and a CANCEL button that allows the user to approve or disapprove the request for the digital signature. In addition, the presented web page may echo the transaction data that is being signed so that the user may review the transaction data. Typically, the key datastore holds a private key of a private/public key pair for asymmetric cryptographic functions. The key datastore may be managed by various entities, such as the browser application, the applet, or the client operating system.

After the user has entered the requested information and indicated that the user approves the use of the user's private key (step 508), the applet generates a digital signature (step 510), preferably in the form of an XML digital signature as standardized by the World Wide Web Consortium (W3C). The digital signature is created by applying an appropriate signing algorithm to the set of data items that are to be subsequently verified, i.e., the so-called “signed info”; in this scenario, the data that is signed would minimally include the transaction data for the pending transaction. An XML signature also includes so called “key info”, which may include the user's public key certificate that should be used to verify the digital signature. The applet then sends the XML signature (including the transaction data) to the web server (step 512), and the process of generating the digital signature is complete. The applet may optionally store a record that it generated a digital signature in a signature log at the client.

With reference now to FIG. 6, a flowchart depicts a process for intercepting transaction data at a web server and enforcing the capture of a digital signature for the pending transaction prior to forwarding the transaction data to a web application. The process begins with the web server plug-in again filtering or examining the incoming data from the client in a manner similar to that described at step 402 in FIG. 4.

The plug-in intercepts the XML signature with the included transaction data that is being submitted by the client as requested by the plug-in (step 602). The plug-in forwards the XML signature to the signature verifier servlet (step 604), which validates the digital signature (step 606) and returns an indication of the verification results to the plug-in (step 608). If a public key certificate was not received along with the XML signature, then the signature verifier servlet retrieves the user's public key certificate, e.g., by extracting user identification information from the XML signature and querying a directory for the user's digital certificate. Assuming that the digital signature on the transaction data was successfully verified, then the plug-in stores the signature in the server's signature log (step 610) and sends a signature record/receipt to the applet at the client's browser (step 612); the applet subsequently records the signature receipt in the client's signature log. Recordation of the digital signature by both parties to a transaction provides evidence to both parties to support non-repudiation of a transaction by either party. The plug-in then forwards the transaction data to the destination web application (step 614), and the process is complete.

The advantages of the present invention should be apparent in view of the detailed description that is provided above. The present invention transparently adds digital signature functionality to web servers in order to extend the web servers to generate and enforce signatures on behalf of web applications. A security proxy intercepts transaction data that is submitted by a client to a web application. The security proxy causes the client to generate a digital signature on the intercepted transaction data through a provided applet, which returns the intercepted transaction data along with the newly generated signature. The security proxy records the client's signature and provides the transaction data to the destination web application. The operator of a domain obtains the advantages provided by digital signatures, such as verifiable identity and non-repudiation of transactions, with the avoidance of modifications to web applications and client applications.

It should be noted that, in the present invention, the digital signature capability is inserted into the transaction processing after the transaction data is submitted to the web server. If the digital signature capability was inserted into the transaction processing before the transaction data was submitted to the web server, e.g., by injecting an applet into a form that was being transmitted to a client by a web application, then the secondary form generator servlet would need to have significant information for the specific forms that any web application might send to the client. By enforcing the collection of a digital signature after the web form has been submitted by the user, the secondary form generator servlet does not have to inspect the original web form from a web application. Instead, the secondary form generator servlet creates a digital signature page that contains the digital signature applet, which can ensure that the user only sees one additional step with the secondary form. The user would not be aware of the manner in which the secondary form was generated.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing transactions, the method comprising:
intercepting, at a server, transaction data from a client to a server application;
in response to intercepting the transaction data, generating at the server a document comprising the transaction data and an applet, wherein execution of the applet at the client generates a digital signature on the transaction data; and
sending the document to the client.

2. The method of claim 1 further comprising:
receiving, at the server, a response document from the client, wherein the response document comprises the transaction data and a digital signature on the transaction data that was generated by the applet executing at the client; and
in response to a determination that the received digital signature is valid, forwarding the transaction data to the server application.

3. The method of claim 2 further comprising:
in response to a determination that the received digital signature is valid, logging the received digital signature in a log file at the server.

4. The method of claim 2 further comprising:
in response to a determination that the received digital signature is valid, sending a signature receipt to the applet executing at the client.

5. The method of claim 2 wherein the document and the response document are processed by a plug-in executing at the server.

6. The method of claim 2 wherein the response document comprises an XML (extensible Markup Language) document.

7. The method of claim 1 wherein the document is formatted as an HTML document.

8. The method of claim 1 further comprising:
in response to receiving the transaction data, checking with a policy manager to determine whether a digital signature is required for the transaction data; and
in response to a determination that a policy indicates that a digital signature is required, proceeding to generate the document.

9. An apparatus for processing transactions, the apparatus comprising:
means for intercepting, at a server, transaction data from a client to a server application;
means for generating at the server a document comprising the transaction data and an applet in response to intercepting the transaction data, wherein execution of the applet at the client generates a digital signature on the transaction data; and
means for sending the document to the client.

10. The apparatus of claim 9 further comprising:
means for receiving, at the server, a response document from the client, wherein the response document comprises the transaction data and a digital signature on the transaction data that was generated by the applet executing at the client; and
means for forwarding the transaction data to the server application in response to a determination that the received digital signature is valid.

11. The apparatus of claim 10 further comprising:
means for logging the received digital signature in a log file at the server in response to a determination that the received digital signature is valid.

12. The apparatus of claim 10 further comprising:
means for sending a signature receipt to the applet executing at the client in response to a determination that the received digital signature is valid.

13. The apparatus of claim 10 wherein the document and the response document are processed by a plug-in executing at the server.

14. The apparatus of claim 10 wherein the response document comprises an XML (eXtensible Markup Language) document.

15. The apparatus of claim 9 wherein the document is formatted as an HTML document.

16. The apparatus of claim 9 further comprising:
means for checking with a policy manager to determine whether a digital signature is required for the transaction data in response to intercepting the transaction data; and
means for proceeding to generate the document in response to a determination that a policy indicates that a digital signature is required.

17. A computer program product in a computer readable medium for use in a data processing system for processing transactions, the computer program product comprising:
means for intercepting, at a server, transaction data from a client to a server application;
means for generating at the server a document comprising the transaction data and an applet in response to intercepting the transaction data, wherein execution of the applet at the client generates a digital signature on the transaction data; and
means for sending the document to the client.

18. The computer program product of claim 17 further comprising:
means for receiving, at the server, a response document from the client, wherein the response document comprises the transaction data and a digital signature on the transaction data that was generated by the applet executing at the client; and
means for forwarding the transaction data to the server application in response to a determination that the received digital signature is valid.

19. The computer program product of claim 18 further comprising:
means for logging the received digital signature in a log file at the server in response to a determination that the received digital signature is valid.

20. The computer program product of claim 18 further comprising:
means for sending a signature receipt to the applet executing at the client in response to a determination that the received digital signature is valid.

21. The computer program product of claim 18 wherein the document and the response document are processed by a plug-in executing at the server.

22. The computer program product of claim 18 wherein the response document comprises an XML (eXtensible Markup Language) document.

23. The computer program product of claim 17 wherein the document is formatted as an HTML document.

24. The computer program product of claim 17 further comprising:
means for checking with a policy manager to determine whether a digital signature is required for the transaction data in response to intercepting the transaction data; and
means for proceeding to generate the document in response to a determination that a policy indicates that a digital signature is required.
